(19) United States
(12) Patent Application Publication
(10) Pub. No.: US 2007/0119259 A1
(43) Pub. Date: May 31, 2007

(54) High sensitivity, low noise piezoelectric flexural sensing structure

(76) Inventors: Lichun Zou, Vienna, VA (US); Ken K. Deng, Potomac, MD (US)

Correspondence Address: HELLER EHRMAN LLP, 275 MIDDLEFIELD ROAD, MENLO PARK, CA, 94025-3506, US

(21) Appl. No.: 11/515,416

(22) Filed: Sep. 1, 2006

Related U.S. Application Data
(63) Continuation-in-part of application No. 11/011,198, filed on Dec. 15, 2004, now Pat. No. 7,104,140.

(51) Int. Cl. G01B 7/16

(52) U.S. Cl. 73/777

(57) ABSTRACT

A piezoelectric flexural sensing structure having increased sensitivity and decreased noise, without sacrifice of the sensor bandwidth. The structure is made up of a proof mass, a beam with a base and optionally having castellated bonding surfaces and two <011> poled bending mode relaxor piezoelectric crystal plates mounted on the beam.

### CROSS-REFERENCE TO RELATED APPLICATIONS

This application is a continuation-in-part of U.S. Ser. No. 11/011,198 filed Dec. 15, 2004, which application is fully incorporated herein by reference.

### GOVERNMENT INTEREST

The present invention was made under United States Navy Office of Naval Research Contract No. N00014-02-M-0171.

### FIELD OF THE INVENTION

The present invention is directed to a piezoelectric flexural sensing structure having increased sensitivity and decreased noise, without sacrificing bandwidth.

### BACKGROUND OF THE INVENTION

Conventionally, a piezoelectric coefficient d₃₁ value of piezoelectric materials, such as PZT, <100> poled relaxor-based single crystal such as PMN-PT, is about the half value of its piezoelectric coefficient d₃₃. Due to reduced piezoelectric properties compared to the d₃₃ mode, a heavy mass (large size sensors) or narrow bandwidth must be adapted to achieve high piezoelectric output. All the old solutions suffered from either lower piezoelectric output (high noise level) or reduced bandwidth when a senor was kept to the same size.

### SUMMARY OF THE INVENTION

An object of the present invention is to provide a piezoelectric flexural sensing structure with increased sensitivity and decreased noise.

Another object of the present invention is to provide a piezoelectric flexural sensing structure with much higher charge sensitivity and lower noise.

Yet another object of the present invention is to provide a piezoelectric flexural sensing structure that has one or more piezoelectric single crystals which possesses the highest piezoelectric coefficient d₃₁ value than all other poling directions.

A further object of the present invention is to provide a piezoelectric flexural sensing structure that has at least one <011> poled bending mode, relaxor-based piezoelectric crystal.

These and other objects of the present invention are achieved in a piezoelectric flexural sensing structure that includes a beam and a base to which a first end of the beam is attached. A proof mass is attached to a second end of the beam. A <011> poled relaxor piezoelectric single crystal is provided.

In another embodiment of the present invention, a piezoelectric flexural sensing structure includes a beam and a base to which a first end of the beam is attached. A proof mass is attached to a second end of the beam. A pair of <011> poled relaxor piezoelectric single crystals are mounted on castellations on opposite sides of the beam.

In another embodiment of the present invention, a piezoelectric flexural sensing structure has a beam with a pair of mounting surfaces. The mounting surfaces are selected from the group of mounting surfaces having no castellations thereon and those having castellations thereon. A base is provided that is attached to a first end of the beam. A proof mass is attached to a second end of the beam. A pair of <011> poled relaxor piezoelectric single crystals are mounted on mounting surfaces of said beam.

### BRIEF DESCRIPTION OF THE DRAWINGS

FIG. 1 illustrates one embodiment of the present invention showing a piezoelectric flexural sensing structure with <011 > poled relaxor piezoelectric crystals.

FIG. 2 illustrates another embodiment of the present invention with a piezoelectric flexural sensing structure combined with a lateral constraint alleviation mechanism.

### DETAILED DESCRIPTION OF THE PREFERRED EMBODIMENT

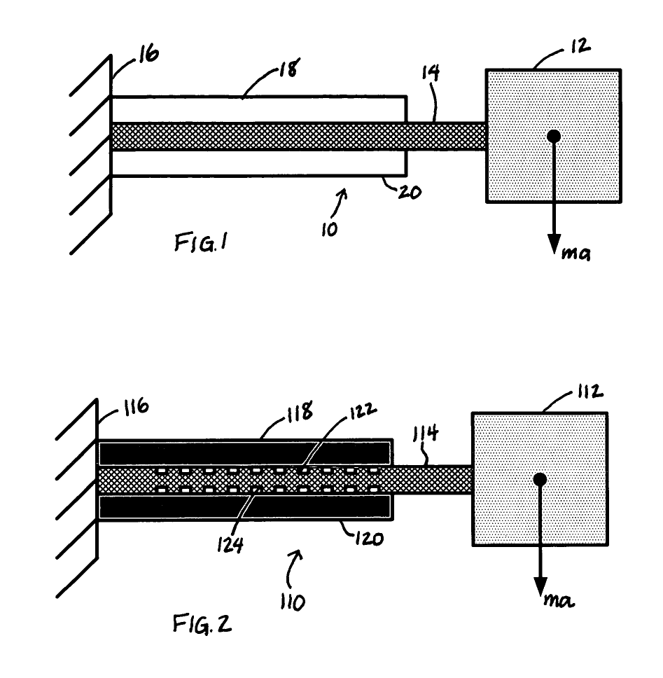

In one embodiment of the present invention, illustrated in FIG. 1, a piezoelectric flexural sensing structure has a bending mode using two piezoelectric crystals mounted on a beam is selected as a basic sensing element. This sensing structure 10 consists of a proof mass 12, a beam 14 with a base 16, and two <011> poled bending mode relaxor piezoelectric crystal plates 18, 20 mounted on opposite surfaces of the beam 14. Suitable <011> poled relaxor-based piezoelectric single crystals include but are not limited to, PMN-PT, PZN-PT, PYN-PT, and the like, Relaxor piezoelectric crystals are a family of crystals that have similar characteristics. The examples provided herein are given by way of illustration, are not intended to limit the scope of the claims, and generally have the highest piezoelectric properties for that family. The <011> poled relaxor piezoelectric single crystal plates 18, 20 have about 40% higher d₃₁ piezoelectric coefficient when compared to other poling orientations. This structure is a significant improvement in piezoelectric output of the sensing structure 10.

In a second embodiment of the invention, a piezoelectric flexural sensing structure has a bending mode using two piezoelectric crystals on a beam is also selected as a basic sensing element and has an additional feature. This sensing structure 110, which is shown in FIG. 2, consists of a proof mass 112, a beam 114 with a base 116, and two <011> poled bending mode relaxor piezoelectric crystal plates 118, 120 mounted on opposite surfaces of the beam 114. Two unique features are incorporated in this sensing structure. First is that the <011> poled relaxor single crystal plates 118, 120 have about 40% higher d₃₁ piezoelectric coefficient when compared to other poling orientations. The second is that the bonding surfaces 122, 124 are castellated, i.e., the protrusions 122, 124 are made on the beam gluing surfaces in order to reduce the bonding area on the crystal plates 118, 120 and effectively mitigate the lateral constraint from the gluing surface on the crystal. This results in a significant improvement in the piezoelectric output of the sensing structure 110. The use of castellations to improve sensor performance is disclosed in U.S. Pat. No. 6,715,363, incorporated herein by reference.

With the present invention, the <011> poled relaxor-based piezoelectric single crystals increase the sensitivity and decrease the noise of the piezoelectric flexural sensing structure. By utilizing a <011> poled relaxor piezoelectric single crystals, which possesses the highest piezoelectric coefficient d₃₁ value, combined with a novel lateral constraint (clamping effect) alleviation mechanism, the present invention provides a piezoelectric flexural sensing structure with much higher charge sensitivity and with lower noise.

Previously, as contrasted with the present invention, <100> poled relaxor single crystal, such as PMN-PT, or other piezoelectric materials have been used that have low piezoelectric coefficient d31 values. The use of a <100> poled relaxor single crystal results in low piezoelectric output and high noise. In contrast, the embodiments of the present invention use new piezoelectric materials, a <011> poled relaxor single crystal and a unique bonding surface. In one embodiment of the present invention, instead of flat bonding surfaces, surfaces with protrusions, castellations, are used to reduce the percentage of the bonding area. The patterns of the protrusions can have various forms including but not limited to, circular islands, square pillars, cut multiple grooves on the surface, and the like. Further discussion of bonding surfaces can be found in U.S. Pat. No. 6,715,363, incorporated herein by reference. This results in the piezoelectric flexural sensing structures presenting a higher sensitivity and lower noise with same dimensions of the sensing structure.

The performance comparison shows that the application of <011> poled relaxor crystal with a bending mode sensing structure results in an increase of the piezoelectric output for the sensing structure by a factor of two (˜6 dB). Consequently, it decreases noise level by 6 dB, which meet today's high technology demands on the sensor noise level.

### EXAMPLE 1

A cantilever, bimorph sensing structure includes <011> poled bending mode, relaxor-based piezoelectric crystals. The following improvements in the piezoelectric outputs are observed: charge sensitivity increases by 51% and voltage sensitivity increases by 122%. As a result of these sensitivity improvements, the minimum detectable signal for the sensor (or the noise floor) is lowered by 6 dB.]

Expected variations or differences in the results are contemplated in accordance with the objects and practices of the present invention. It is intended, therefore, that the invention be defined by the scope of the claims which follow and that such claims be interpreted as broadly as is reasonable.

What is claimed is:

1. A piezoelectric flexural sensing structure comprising:
(a) a beam;
(b) a base to which a first end of the beam is attached;
(c) a proof mass attached to a second end of the beam; and
(d) a <011> poled relaxor piezoelectric single crystal.

2. The piezoelectric flexural sensing structure of claim 1, wherein the beam includes castellations to which the <011> poled relaxor piezoelectric crystal is attached.

3. The piezoelectric flexural sensing structure of claim 1, further comprising two <01

4. The piezoelectric flexural sensing structure of claim 3, wherein the beam includes castellations to which the <011> poled relaxor piezoelectric crystals are attached.

5. A piezoelectric flexural sensing structure comprising:
(a) a beam having castellations on two sides;
(b) a base to which a first end of the beam is attached;
(c) a proof mass attached to a second end of the beam; and
(d) a pair of <011> poled relaxor piezoelectric single crystals, said crystals mounted on castellations on opposite sides of the beam.

6. A piezoelectric flexural sensing structure comprising:
(a) a beam having at least one mounting surface, said at least one mounting surface selected from the group of surfaces having no castellations thereon and those having castellations thereon;
(b) a base to which a first end of the beam is attached;
(c) a proof mass attached to a second end of the beam; and
(d) at least one <011> poled relaxor piezoelectric single crystal, said at least one <011> poled relaxor piezoelectric crystal mounted on said at least one mounting surface of said beam.

7. A piezoelectric flexural sensing structure comprising:
(a) a beam having a pair of mounting surfaces, said mounting surfaces selected from the group of mounting surfaces having no castellations thereon and those having castellations thereon.
(b) a base to which a first end of the beam is attached;
(c) a proof mass attached to a second end of the beam; and
(d) a pair of <011> poled relaxor piezoelectric single crystals, said crystals mounted on the mounting surfaces of said beam.
